(19) United States
(12) Patent Application Publication
(10) Pub. No.: US 2003/0135507 A1
(43) Pub. Date: Jul. 17, 2003

(54) System and method for managing and securing meta data using central repository

(75) Inventors: John R. Hind, Raleigh, NC (US); Marcia L. Stockton, Bakersfield, CA (US)

Correspondence Address: Jeanine S. Ray-Yarletts, IBM Corporation T81/503, PO Box 12195, Research Triangle Park, NC, 27709, US

(73) Assignee: International Business Machines Corporation, Armonk, NY

(21) Appl. No.: 10/051,951

(22) Filed: Jan. 17, 2002

(51) Int. Cl. G06F 7/00

(52) U.S. Cl. 707/100

(57) ABSTRACT

A method and system for managing meta data using a central repository are disclosed. The method manages meta data for a user using the central repository at a central repository subsystem, wherein the central repository is accessible by a computing device through a communication network. The method includes the steps of connecting to the central repository through the communications network based on a user input; updating a local repository of the computing device with at least one segment from the central repository that is associated with the user to produce a meta data collection associated with the user; and utilizing, by the computing device, the meta data collection during a current user session at the computing device to assist the user in using the computing device.

### RELATED APPLICATION

The present application is related to a co-pending U.S. application Ser. No. ______ (Attorney Docket No. RSW020010101US1), filed concurrently herewith on ______, entitled “System and Method for Managing and Securing Meta Data”, and assigned to the assignee of the present invention, which is herein fully incorporated by reference.

### BACKGROUND OF THE INVENTION

1. Field of the Invention

The present invention relates to data management systems and, more particularly, to a system and method for managing and securing meta data using a central repository.

2. Discussion of the Related Art

Meta data is known as any data that relates to or describes some other data. Examples of meta data can include, but are not limited to, web page setting parameters (e.g., font, font size, background color, window size, etc.), user IDs and passwords, and values entered into the data fields of computer forms such as online order forms. Conventional Web browsers such as Microsoft Internet Explorer offer limited meta data management features. For example, an “auto-complete” function offered by Microsoft Internet Explorer manages meta data such as Web addresses, passwords, and contact information that the user enters into the data fields of computer forms. Subsequently, when the user begins to enter a value into a particular data field of a computer form previously processed by the user's browser, the auto-complete function provides a drop-down list suggesting possible values for that data field. The user's selection of one of the suggested values triggers the browser to automatically fill in the data field with the selected value.

One popular feature of the auto-complete function is the “password-assist” feature for assisting the user in filling in passwords and user IDs. For instance, when the user enters a user ID and a password into the appropriate data fields of a computer form for the first time, the auto-complete function of the Web browser stores the user ID and password in association with the data fields identified by particular field names. The user ID and password are typically stored in an encrypted format in a local repository such as the memory of the user's PC. Then, each time the same data fields appear on the user's screen, the auto-complete function retrieves the corresponding user ID and password and decrypts them. Then the auto-complete function automatically fills in the data fields with the decrypted user ID and password. Typically, the password in the “password” field of the form is obfuscated by being displayed as a string of asterisks.

Although such conventional meta data management systems are intended to be beneficial, there are problems or limitations that are associated with the conventional systems. First, in conventional Web browsers, all web pages are displayed using the same web page settings regardless of time, website, user role indicating different roles of a user (e.g., an IBM employee, a private person, or a club representative), and other variables. But, one or more users of the computer may prefer different display settings depending on the website, user role, etc. For example, the user may prefer to always view a particular website in medium font size and dark background color on the user's computer, whereas the same user may prefer to view a different website in extra large font size and bright background color on the same computer. In the conventional systems, if the user desires to view a particular page in different display settings (e.g., with larger font size), then the user must manually change the display settings, at which time, all subsequent web pages will be displayed according to the newly set display settings. Thus, the conventional Web browsers require the user to manually change the web page settings at each desired instance. This can be tedious and time consuming to the user, and negatively affects the Web browsing experience of the user.

Another problem not addressed by conventional meta data management systems is that the conventional systems are not configured to recognize different meta data associated with different roles of a user. For instance, the user may function as an IBM employee, an association representative, or a private citizen (personal use) when ordering products online from a particular online vendor. Depending on the user role, the user utilizes different meta data such as different user ID/and password, mailing address, payment information, etc. However, regardless of the current user role, the conventional Web browsers always supply the last used meta data when filling in forms, which is often inappropriate for the current user role.

Another problem with conventional systems is that the conventional system does not recognize relationships between data fields of forms and pages so that the field values are often used out of context. For instance, an online order form may request a home address comprising four related data fields, namely, street name, city, state and zip code. Although these data fields are related, the conventional system stores values for each of these fields individually and does not store relational information on these fields. Thus, when the conventional Web browser provides a drop-down list identifying suggested values for a particular data field, the drop-down list often includes certain items that are completely irrelevant for the particular data field. Moreover, since the conventional Web browser is unable to recognize related data fields, a large number of items are often displayed in one drop-down list. As the number of items displayed in the drop-down list increases, it becomes more difficult for the user to view the list and find quickly the appropriate value from the list.

Another problem with the conventional systems is that the drop-down list is displayed for one data field at a time and triggered in response to the user's manual input of some value into the data field. This means that the user must type in the value to see the appropriate drop-down list and needs to repeat this process for each and every data field in the form. Thus, the conventional form filling process can be inconvenient and time consuming to the user.

Yet another problem with the conventional systems is the “password-assist” feature offered by the auto-complete function of the system. Although the “password-assist” feature provides some benefits to the user because the user does not need to remember multiple user IDs and passwords, this feature can have the unpleasant side effect of helping the user forget her user IDs and passwords since the browser automatically fills the user ID/password fields in most cases. Further, when a password requesting form has a field name which is different from the stored field name associated with the password, the auto-complete function fails to recognize this field and the user will need to manually enter the password into the field. Furthermore, when a password changing form includes a field for entering the old password, which often has a field name unrecognized by the browser, the auto-complete function will not supply the old password and the user will need to enter it manually. But, since the user is so used to the browser automatically filling in the passwords, the user typically fails to recall the appropriate password, which places the user in problematic situations.

In addition to the above-described problems associated with conventional meta data management systems, there are other needs that are unmet by the conventional systems. For example, it would be desirable to have some means by which a user can inspect, edit and/or organize stored meta data both online and offline. It would also be desirable to have some means to intelligently search for certain meta data from a pool of stored meta data, and to be able to select certain meta data for insertion into forms. It would also be desirable to enable a user to customize a number of different display settings for each different website, page, file, and/or user role and to provide some means for implementing such display settings appropriately depending on the requested website, page, file and/or user role.

Finally, another unmet need of the conventional systems is the ability to securely access meta data from multiple computing devices, e.g., from a user's office desktop, home PC, mobile web-pad, and perhaps a web appliance at a local Internet café. This should be done in a fashion that minimizes network traffic without compromising security. And, it would be cost-effective to implement such a system using at least a portion of the existing protocols and standards, if this is possible. The new system will improve greatly the mobility of the user since the user will be able to switch between multiple computing devices at different locations to access and use meta data.

### SUMMARY OF THE INVENTION

The present invention provides a system and method for managing and securing meta data using a central repository, which overcomes problems associated with conventional meta data management systems and which satisfy the above-described needs of the conventional systems. The system of the present invention provides an innovative and sophisticated approach for assisting the user with application-based activities such as filling in a computer form, word-processing a file, requesting a website, changing a password online, etc. The system collects meta data in association with the context in which such meta data are generated from multiple computing devices (with the premise that the user uses only one of the computing devices at any given time) and stores them at a central repository in the collection order. Then, from any one of the computing devices, all meta data associated with the user can be downloaded from the central repository and heuristically exploited to assist the user with application-based activities at that computing device. The system provides mobility to the user and greatly enhances the experience of the user in conducting application-based activities at any one of the computing devices.

One of the main benefits of the present invention is that it utilizes existing central repositories and their communication protocols (e.g., WebDAV) without requiring special code or changes to provide the advantageous features discussed below.

Particularly, the system of the present invention comprises a plurality of different computing devices located at different places, and a central repository subsystem accessible from any one of the computing devices through a communications network such as the Internet. At the start of a user session at a particular computing device, the computing device connects to the central repository subsystem based on user input. Then, the central repository subsystem transmits any segment(s) that are currently stored in the central repository for the user, but have not been applied to the computing device in association with the user. Each segment carries meta data generated during a user session, which is represented as logged changes from previous contents in the collection order. The computing device receives these segments (if available) from the central repository subsystem, decrypts them, and applies them to a local repository (i.e., to the user's meta data collection stored in the local repository of the computing device). This process updates the user's meta data collection at the computing device to be consistent with the user's segments stored in the central repository.

Then, the computing device utilizes the updated meta data collection to assist the user in using applications (e.g., Web browser, word processor, etc.) during the current user session at the computing device. To accomplish this, the computing device is configured to interact with the applications currently active on the computing device, and to heuristically search and retrieve certain meta data from the user's meta data collection that would be most appropriate for use in the current context of using the applications. For instance, if the Web browser is currently being used to fill a computer form, then meta data (field values) that can be automatically filled into the fields of the computer form would be searched and retrieved from the user's meta data collection. The retrieved meta data would then be automatically filled into the fields of the computer form.

In the meta data collection, all the meta data that are related to each other or used together in a particular context are associated together. This permits the system to recognize and consider relationships between the meta data when accessing the stored meta data. In addition, the system maintains statistical information indicating how frequently certain meta data have been used together in a particular context. The system relies on the statistical information during its search and retrieval operation.

More specifically, the computing device performs sophisticated search and retrieval operations on the local repository to utilize the user's meta data collection to perform automatically certain tasks for the user. Since the meta data and the statistical information represent the user's past behaviors in using the applications, whether it be filling in a computer form, displaying a web page or file, etc., the system relies on this prior use information to anticipate the likely behavior of the user during a current use of the application, and retrieves from the meta data collection certain meta data that would be most appropriate for the current context of using the application. This process is implemented using existing heuristics algorithms to find optimal solution(s) that satisfy multiple search requirements. In one embodiment, the search requirements are formulated based on different properties (e.g., Uniform Resource Identifier—also called URI, user role, etc.) that identify the current context of using the application. These different context properties are assigned different weights (representing different degrees of importance) to find solution(s) that would be most appropriate for the current context. The identified solution(s) will represent meta data that the user will likely use in the current context of using the application. Then the system applies automatically the identified solution(s) in the user's current context of using the application.

The present system also provides a meta data editor that allows the user to organize, sort and edit the user's meta data collection stored in the local repository using a graphical user interface. Using the editor, the user can select, from multiple possible values, most appropriate values to be inserted into a form on demand by using an existing selection technique such as a drag-and-drop editing operation.

During the user session, the computing device is configured collect meta data as logged changes which result from using the applications and/or meta data editor. Upon completion of the user session at the computing device, the computing device temporarily locks the local database, creates a segment based on the collected meta data (in logged changes), encrypts the segment with an encryption key, transmits the encrypted segment to the central repository for storage, resets its internal log file for future logging, and then unlocks the local database. The encryption key may be formulated based on the user's pass phrase and the identifier of the new segment. In this manner, meta data generated from different computing devices can be collected in sequence and stored at a central location to be downloaded subsequently to the next computing device that the user desires to use.

Accordingly, all the meta data produced from different computing devices are deposited in order as encrypted segments at a central location and are subsequently downloadable from any one of the computing devices. The use of encrypted segments (logged changes) minimizes network traffic and downloading time and improves the security of the system. The present invention intelligently provides suggestions or implements changes to the current context of using a computing device in a manner that the user would likely have chosen. Thus, the user need not manually effectuate such changes for each different instance of using the computing device at a particular computing device, whether it be filling in a computer form, changing the display setting of a page/file, changing a password, etc. As a result, the user can readily enjoy the automation and customization features of the present invention from any computing device.

### BRIEF DESCRIPTION OF THE DRAWINGS

FIG. 1 is a diagram of a system for managing and securing meta data using a central repository according to one embodiment of the present invention.

FIG. 2 is a block diagram of each computing device in the system shown in FIG. 1 according to one embodiment of the present invention.

FIG. 3A is a diagram of an example of a computer form usable in the present invention.

FIG. 3B shows an example of (key, value) pairs collectable from the computer form of FIG. 3A according to one embodiment of the present invention.

FIG. 4 is a flowchart illustrating the processing steps of a method for managing meta data using a central repository according to one embodiment of the present invention.

FIG. 5 is a flowchart illustrating the processing steps of Step S20 in FIG. 4 according to one embodiment of the present invention.

FIG. 6 is a flowchart illustrating the processing steps of Step S40 in FIG. 4 according to one embodiment of the present invention.

FIG. 7 is a flowchart illustrating the processing steps of Step S60 in FIG. 4 according to one embodiment of the present invention.

FIG. 8 is a flowchart illustrating the processing steps of Steps S45 and S46 in FIG. 6 in the context of displaying web pages according to one embodiment of the present invention.

FIG. 9 is a flowchart illustrating the processing steps of Steps S45 and S46 in FIG. 6 in the context of filling in forms according to one embodiment of the present invention.

FIG. 10 is a flowchart illustrating the processing steps of Steps S45 and S46 in FIG. 6 in the context of changing passwords according to one embodiment of the present invention.

### DETAILED DESCRIPTION OF THE PREFERRED EMBODIMENTS

In the drawings, the same reference numerals are used to indicate the same elements. The term “repository” generally means one or more databases, but can include other storage means for storing data and information.

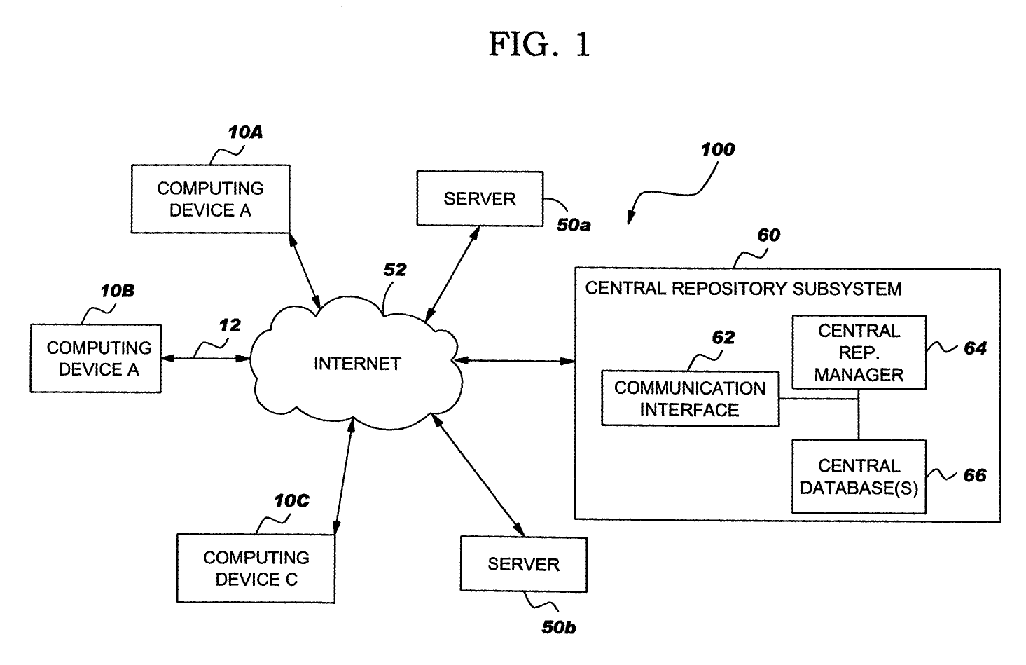

FIG. 1 is a diagram of a system 100 for managing and securing meta data using a central repository according to one embodiment of the present invention. As shown in FIG. 1, the system 100 includes a plurality of different computing devices 10A, 10B, and 10C (collectively 10) accessible by one or more users, and a central repository subsystem 60, all operatively coupled. The computing devices 10 are capable of communicating with the central repository subsystem 60 and with a plurality of different servers 50a and 50b (collectively 50) through a communications network such as the Internet 52. The central repository subsystem 60 is also capable of communicating with the servers 50 through the communications network. Each of the computing devices 10 can be, for example, a computer, a work station, a mobile web-pad, a PDA (Personal Digital Assistant), a mobile telephone, or any other communication device capable of carrying out functions discussed below. The computing devices 10 can be located at different places (e.g., one at the user's home, another one at the user's office, etc.), or can be publicly-shared devices such as library computers. The servers 50a-50b are conventional servers or other means for providing and maintaining websites.

The central repository subsystem 60 comprises a communication interface 62 for allowing the subsystem 60 to communicate with external sources such as the computing devices 10 and the servers 50, a central repository including one or more central databases 66 for storing encrypted segments in collection order for each of the different users in the system 100, and a central repository manager 64 for managing the central databases 66, all operatively coupled.

In a preferred embodiment of the present invention, the central repository is accessed via known “Web-based Distributed Authoring and Versioning (WebDAV)” protocols, and supports the “ordered collections” and “locking” features of the WebDAV protocols known in the art. As known, WebDAV is an extension to the HTTP 1.1 protocol (see, e.g., http://www.ics.uci.edu/pub/ietf/webdav/intro/webdav_intro.pdf) and is implemented by a wide range of commercial repository products (see, e.g., http://www.ietf.cnri.reston.va.us/rfc/rfc2518.txt for base protocol, http://www.ietf.cnri.reston.va.us/html.charters/webdav-charter.html for information on extensions and implementations). In simple terms, WebDAV protocols allow a ‘client’ to view a repository ‘server’ as if it were an access controlled file system. A “userid” identifying a user (client) can be used to scope the files in the repository server which are available for manipulation as well as the operations that may be performed, and a “password” from a user can be used to authenticate the “userid” that a particular client claims. Based on the “userids” and “passwords”, WebDAV protocols allow different users to access particular data from a central storage location (central repository) and to edit such data directly at that location. The “ordered collections” feature maintains modifications to the data at the central storage location in the collection order. To prevent different users from rendering modifications simultaneously, the WebDAV protocols provide the “locking” feature that allows only a single user to access a particular file at any given time. For instance, if user B desires to access a particular file when user A is currently accessing the file, the WebDAV system would block the access by the user B and inform user B of unavailability of the desired file. A more detailed discussion on WebDAV protocols and features can also be found at the website of http://www.webdav.org/. By using the existing WebDAV protocols in the central repository subsystem 60, the present invention eliminates the need to use special code typically used in prior art database systems.

In still preferred embodiment, existing “RFC2069 Digest Access Authentication” protocols can be further implemented in the central repository subsystem 60 so that decryption keys and other access authorizing information would not be disclosed to network monitors. For instance, RFC2069 (see, e.g., http://www.ietf.org/rfc/rfc2069.txt) HTTP extension can be used in the process of authenticating the “userid” with the client's “password”.

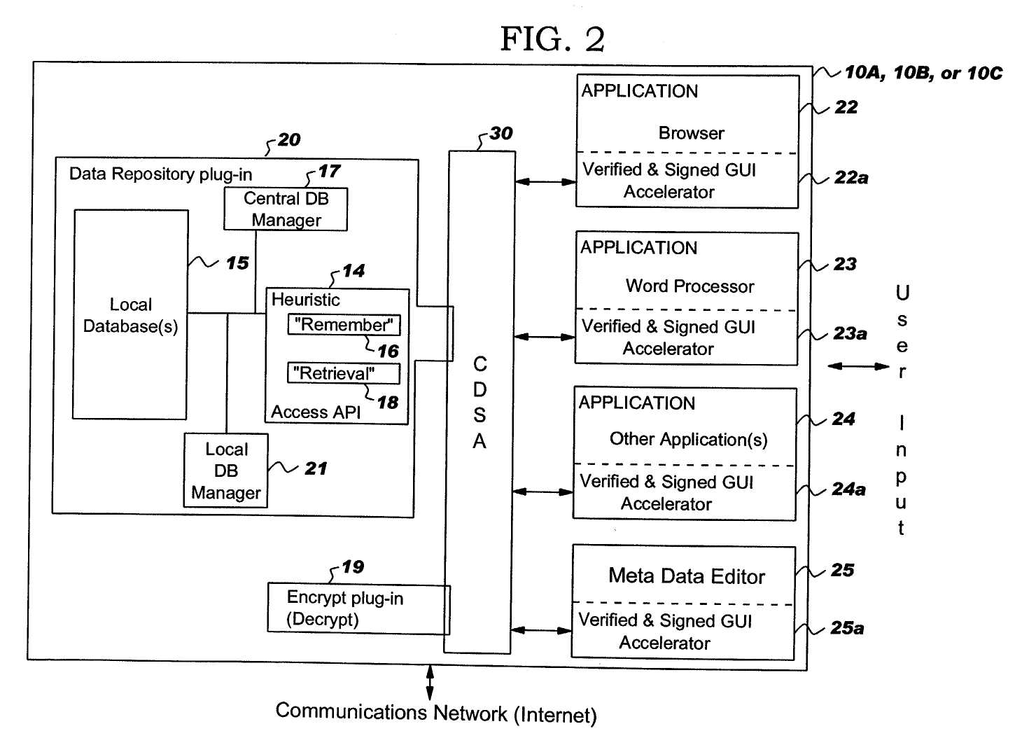

FIG. 2 is a block diagram of each computing device 10A, 10B or 10C in the system 100 of FIG. 1 according to a preferred embodiment of the present invention. For the sake of brevity, the computing device 10A will be described. However, all the computing devices 10 have the same components and operate in the same manner. As shown in FIG. 2, the computing device 10A includes Common Data Security Architecture (CDSA) 30, an encrypt/decrypt plug-in 19, a data repository plug-in 20, a plurality of applications such as a Web browser 22, a word processor 23 and/or any other application(s) 24, and a meta data editor 25, all operatively coupled.

The CDSA 30 is an existing security layer configuration for providing a widely-accepted set of layered security services defined by Intel Architecture Labs (IAL). Typically, the CDSA is implemented as computer software. Briefly, the functions and operations of the CDSA 30 will be discussed. The CDSA 30 includes a Common Security Services Manager (CSSM) API (application programming interface) that interacts with the applications 22-24 and the editor 25 to allow the applications 22-24 and the editor 25 to access the security services offered by the CDSA 30. The CDSA 30 also includes a plurality of service provider modules that offer these security services. Among the known service provider modules, the CDSA 30 may include a Cryptographic Service Provider (CSP) module, a Trust Policy (TP) module, a Certificate Library (CL) module, a Data storage Library (DL) module, and an Authorization Computation (AC) module, all known in the art. These modules provide services such as cryptographic operations including bulk encrypting and digital signature processing, accessing remote signing entities such as Certification Authorities (CA), storing certificates and cryptographic keys, etc. In addition, the CDSA 30, as known, includes elective module managers (EMM) that allow new services to be added easily. Under control of the EMM, new services can be added easily in a secure manner by merely providing new service provider modules as plug-ins that implement the new services. The process of adding and integrating the new service modules as plug-ins into the CDSA 30 is known in the art. More detailed operations and functions of the service provider modules and the CSSM API as well as the overall architecture of the CDSA 30 can be found at the website of http://developer.intel.com/ial/security/.

Each of the applications 22-24 and the meta data editor 25 is configured to interact with the CDSA 30. In this regard, each of the applications 22-24 and the meta data editor 25 includes a Graphical User Interface (GUI) accelerator 22a, 23a, 24a or 25a for “accelerating” or facilitating the display and user-interface operations of the application and the editor. These GUI accelerators 22a-25a are known in the art and, as is well known, may require some hardware to implement the functions. Through the GUI accelerators 22a-25a or any other designated component of the applications 22-24, the applications 22-24 and the editor 25 access the security-based services provided by the CDSA 30. For instance, the GUI accelerator 22a of the Web browser 22 communicates with the CSSM API of the CDSA 30 according to existing techniques to access any one of the security-based services provided by the service provider modules such as CSP module, TP module, etc., whenever it is necessary. In one example, if a particular web page received by the Web browser 22 requires decryption, then the Web browser 22 communicates, via the GUI accelerator 22a, with the CSSM API to utilize the decryption service offered by the CSP module of the CDSA 30. Thus, with the help of the CDSA 30, any of the applications 22-24 and the editor 25 in the computing device 10A can carry out data communications with each other and any other communicating component in a secure manner.

The CDSA 30 also verifies each of the GUI accelerators 22a-25a before the GUI accelerators 22a-25a can access the security-based services offered by the CDSA 30. This verification can occur according to existing verification techniques that are used in communication systems to authenticate the validity of communication devices. In this regard, the use of the CDSA 30 further enhances the data security of the computing device 10A.

The encrypt/decrypt plug-in 19 and the data repository plug-in 20 are provided as new service provider modules to the CDSA 30, so that they can be easily integrated into the CDSA 30 to interact with the CSSM API of the CDSA 30 under control of the EMM. This configuration allows the plug-ins 19 and 20 to communicate with each other and with any of the applications 22-24 and the meta data editor 25 and to access any meta data being processed by the applications 22-24 and the meta data editor 25 in a secure manner. In another embodiment, the functions of the plug-ins 19 and 20 can be combined into a single plug-in to the CDSA 30.

The data repository plug-in 20 includes a local repository having one or more local databases 15, a local database manager 21, a central database manager 17, and a Heuristic access API (HAPI) 14, all operatively coupled. The local database manager 21 manages the local databases 15. The central database manager 17 interacts with the local databases 15 and the central repository subsystem 60 via the communications network such as the Internet 52.

An important aspect of this invention is that existing central repositories and their current communications protocols (e.g., WebDAV) can be used without requiring modifications, as long as they are configured to allow the central database manager 17 to save, retrieve, list and/or delete data units (also referred to herein as “segments”) via their respective communications protocols.

At the start of each user session at a computing device, the central database manager 17 requests the user to input “connection” information that will allow the central database manager 17 to connect via the communications network to the central repository and to input a “pass-phrase” (e.g., “BobsLongStringOfLettersAndNumbers”) which is used to derive keys that will be used to decrypt/encrypt segments in the central repository and/or the local database(s) 15. In the preferred embodiment, the “connection” information needed to connect with the central repository includes: (1) the network name of the server holding the central repository (e.g., “www.myrepository.com”), (2) a “userid” identifying the user (e.g., “bob”), and (3) a “password” associated with the user/userid (e.g., “letmein”). Two techniques can be used in the preferred embodiment to simplify such a user interaction. First, the “userid” and the network server name can be entered in an RFC822 style string that resembles an email address (e.g., bob@www.myrepository.com) and secondly, the “password” used to authenticate the user could be algorithmically derived from the “pass-phrase” already entered by the user using a secure one way hash or other cryptographic method.

In the preferred embodiment, the central database manager 17 interacts with the local database manager 21 using a transactional log interface. Through this process, the central database manager 17 can instruct the local databases 15 to create a log of modifications (add/change/delete) of their internal elementary elements over a set time duration; it can instruct the local databases 15 to apply the modifications contained in an existing log to the current state of the local databases 15; it can instruct the local databases 15 to represent their current state as a log of modifications made to a “null” state database; and it can reset the local databases 15 to a “null” state.

Once the session at the computing device begins, the HAPI 14 collects any meta data processed in or resulting from the use of the applications 22-24 and the meta data editor 25, stores the meta data in the local databases 15 as part of a meta data collection associated with the user (if such storage is allowed), and performs search and retrieval operations to search and retrieve certain meta data from the collection that can be used in the current context in which the user is using the application 22, 23 or 24 or the computing device 10A. A meta data collection is an ordered collection of meta data as updated and stored in the local databases 15 for a particular user. That is, a meta data collection refers to all data stored in the local databases 15 for a particular user, which represents all of the meta data and any statistical information representing the user's prior sessions on the particular computing device and all other computing devices. Under control of the HAPI 14, the meta data collection is used to provide meta data that can be used to automate and customize the operation of the applications 22-24 as the user uses the applications 22-24. Such operations of the HAPI 14 will be discussed later in more detail.

Upon completion of the current user session, the central database manager 17 temporarily locks the local databases 15, creates a new segment from the collected logged changes, encrypts the new segment through the encrypt/decrypt plug-in 19, uploads the encrypted segment to the central repository subsystem 60 through the communications network so that the encrypted segment can be stored in the central database 66 in association with the current user, and then clears or resets its internal log file and unlocks the local databases 15. In another embodiment, as an alternative to the batch update of the central repository with the encrypted segment upon completion of the user session as discussed above, it is possible to transmit, incrementally, changes (meta data) made at the computing device to the central repository subsystem 60, as they occur or periodically.

The update process for the central repository is repeated at the different devices 10 as the user switches between the computing devices 10. For example, when the user starts a new user session at the second computing device 10B, the second computing device 10B will automatically request the central repository subsystem 60 for any segments for the user that have not been applied to the meta data collection maintained in the second computing device 10B. If there are such segments, then the central repository subsystem 60 transmits these segments to the second computing device 10B which in turns applies them to the meta data collection in the second computing device 10B to update the meta data collection in the second computing device 10B. Once the user's meta data collection in the second computing device 10B has been updated, then this meta data collection can be used to assist the user in using the second computing device 10B.

In this manner, the user's segments (logged changes) produced at the different computing devices 10 can be centrally stored and shared among the computing devices 10. It is important to note here that the present invention is premised on the assumption that a user will use only one of the computing devices 10 at a time. Further, by transferring only segments (logged changes) to synchronize the local databases and the central repository, the present invention minimizes network traffic, reduces data errors during data exchange, and accelerates the data synchronization process between the computing devices 10 and the central repository subsystem 60.

The encryption operation of the encrypt/decrypt plug-in 19 in the computing device 10A is now described in more detail. As discussed above, when the user begins a new user session at the computing device 10A, the user is required to enter credentials including the “connection” information and “pass phrase.” The connection information includes (1) the user's identification (e.g., user ID), (2) the user's password, passcode, etc., and (3) the name or identifier of the central repository subsystem 60 (e.g., server number or name for the subsystem 60, is etc.). The “pass phrase” can be used by the subsystem 60 to authenticate the user. All or some of these pieces of information (or at least a portion thereof) are later used to generate an encryption key for encrypting the new segment generated upon completion of the current user session. In different embodiments, the encryption of the segment can occur at the computing device or the subsystem 60. One skilled in the art would appreciate that other types of credentials known in the art can also be used in the encryption operation by the encrypt/decrypt plug-in 19. Examples of other types of credentials may include, but are not limited to, biometric identification, and an X509 certificate and private key.

A segment or a combination of segments stored in the central repository is an encrypted log representing changes made during a user session at a device or all the modifications applied to a null state database to bring the database to a certain level. The name of a segment can be the base 64 encoding of the time-date at which the corresponding log of changes was created. The encryption key of a segment is computed using a secure hash such as SHA1 using the following algorithm pattern:

S-HASH(<segment name>∥S-HASH(<time portion segment name>∥<pass phrase>)).

That is, in one embodiment, the encryption key is represented by a SHA1 hash of the new segment name/identifier, concatenated with the user's pass phrase or password. In another embodiment, the encryption key is represented by a SHA1 hash of the new segment name, concatenated with a SHA1 hash of the time portion of the new segment name, concatenated with the user's pass phrase or password. The segment name/identifier identifies the user session at the particular computing device, and can be represented as a string of some value or some other means. In one embodiment, the segment name/identifier can be a modified base 64 encoding of the time-date of the user session at which the first entry in the new segment is made. A SHA1 hash is generated using a SHA1 hash function well known in the cryptography field. A hash function is an existing technique of generating a “hash” based on an input value (e.g., the time portion of the new segment name). A hash represents a value of fixed length that is extracted from the input value using certain extraction rules. A SHA1 is one of different types of hash functions known in the art. A more detail discussion of a general hash function as well as a SHA1 hash function is provided at the website of http://www.cacr.math.uwaterloo.ca/hac/

which provides downloadable chapters of a book directed to cryptography. One skilled in the art would appreciate that other types of hash functions can be used herein and that other types of cryptography operations may be used to generate the segment identifier/name, and/or the encryption key. Further, the encryption key can be based on a different combination of information. For instance, it can be based on the user ID and at least a portion of the segment identifier or segment identifying information.

By using the encryption key which is based on a combination of the user information and the segment identifying information, the security of the system 100 can be improved significantly because both pieces of information will be needed to decrypt or access the segments. Further, even if an unauthorized person (e.g., a hacker) is able to access one segment, the unauthorized person is not able to access other segments because it requires knowledge of the names/identifiers of the other segments. Thus, the present invention provides a meta data management system with enhanced security.

Now, the operation of the HAPI 14 in the data repository plug-in 20 will be described. The HAPI 14 includes a “Remember” interface 16 and a “Retrieval” interface 18, all operatively coupled. The “Remember” interface 16 communicates with any active application 22, 23 or 24 and/or the editor 25 through the CDSA 30 and thereby collects meta data during the user session as a log of modifications (add/change/delete). Meta data includes “application data” and “context data”. Application data is any data that is directly used in or by the application, e.g., form data (values entered into the fields of computer forms), user ID and password combinations, PKI certificates/private key pairs, user preference data including bookmarks and display setting data including web page display setting data and file display setting data, etc. Context data is any data that identifies the context in which the application data is used. The context data may include, but are not limited to, field names identifying the fields of forms/files, URLs of forms, file names, roles identifying the role in which the user functions in producing the application data, statistical information, etc. The display setting data may include, but are not limited to, font, font size, background color, language encoding, window/screen size, whether to open the window/file with a new process or the existing process, security settings, etc.

In one example, if the user has filled out a computer form using Web browser 22 and sent it to a receiving party by pressing a ‘submit’ button, the “Remember” interface 16 obtains form data (i.e., all the values entered by the user into the data fields of this computer form) and collects it in the databases 15 as application data. The “Remember” interface 16 also collects context data associated with the form data. The context data may identify the names of the fields of the form, URL of the form, current user role (e.g., as a private citizen, an IBM employee, etc.), and any other property identifying the context of this computer form. In another example, if the user makes modifications to the display setting of the currently displayed web page, new display setting data (e.g., modifications from default setting data or entire new display setting data) will be collected as application data in association with corresponding context data (e.g., URI of the page, current user role, etc.). In still another example, if the currently active application is the word processor 23 and the user sets specific display settings or some other properties for the particular document file that the user is working on, then the “Remember” interface 16 collects in the databases 15 these settings or parameters together with corresponding context data which may include the file name, user role, or some other identifier of the file/user.

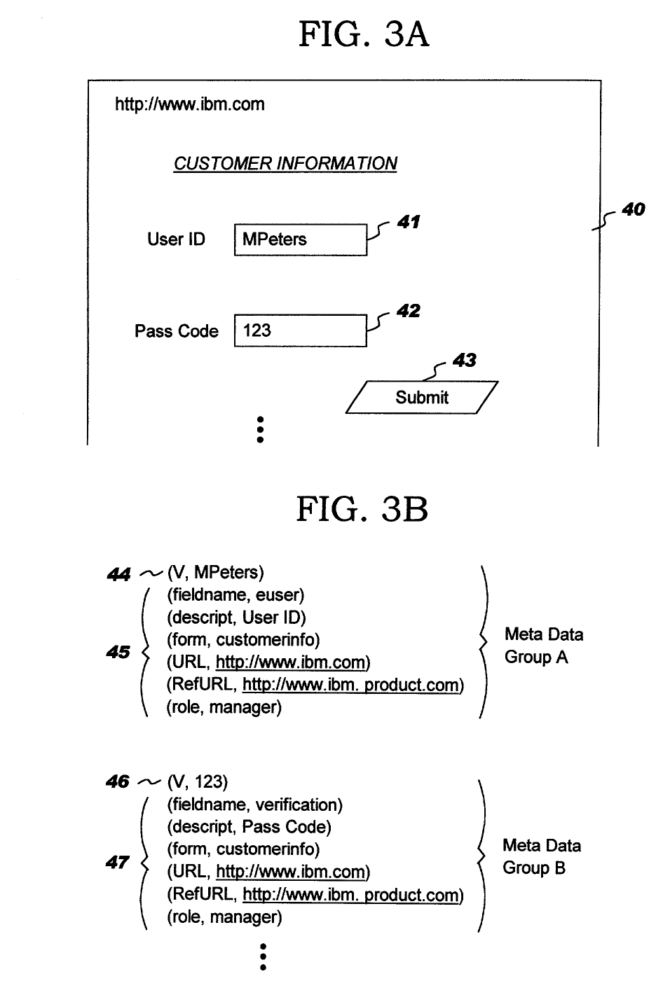

The computing device 10A maintains in the local repository one or more meta data collections, each assigned to a particular user. The current's user's meta data collection (i.e., data stored in the local databases 15 for the current user) is updated at the beginning of the current user's session at the computing device 10A. In one embodiment, the meta data in the meta data collection are represented by a plurality of (key, value) pairs. A “key” represents a particular property and a key value represents a value assigned to the property. For instance, “(URL, www.ibm.com”) indicates that a value of “www.ibm.com” is assigned to the property, URL. For each instance, when the “Remember” interface 16 collects the meta data for a user session at the computing device, the meta data in the meta data collection is organized into a plurality of meta data sets, wherein all the data belonging to a single meta data set will be related to each other. Each meta data set comprises a plurality of meta data groups, each group being composed of a plurality of (key, key value) pairs representing application data and context data associated with the application data. This data organization allows the local databases 15 to be searched based on context data, e.g., a combination of URI, file name, and user role. And with equal importance, this data organization allows related meta data to be associated with each other, so that relationships between the meta data may be considered whenever an access to the user's meta data collection is desired. A more detailed discussion of this data organization will be provided below in connection with FIGS. 3A and 3B.

In addition to collecting meta data, for each user, the “Remember” interface 16 keeps track of the user's use of meta data and stores this information in the databases 15. This information, referred to herein as “statistical information”, contains statistics representing the past behavior of the user in using the applications 22-24 and/or editor 25. The statistical information can be included as part of the context data if desired. It is important to note that this statistical information is updated upon each use of the application 22-24 and/or the editor 25, so that the statistical information reflects the user's usage patterns across multiple “remember” invocations by the “Remember” interface 16. This means that the “remembering” or collecting of meta data by the “Remember” interface 16 may need to occur in every use of data, e.g., every time a form is filled out or every time a web page is loaded. In one embodiment, the statistical information indicates how frequently certain meta data or a particular combination of (key, value) pairs are used together. For instance, if the user functions as a private person or an employee whenever the user accesses a website A, then the “Remember” interface 16 maintains statistics on the frequency in which each of the role “private” and the role “employee” of the user is used together with the URL of the website A.

During each user session at the computing device 10A, the “Retrieval” interface 18 performs search and retrieval operations to utilize the user's meta data collection available from the local databases 15 in assisting the user in using the applications 22-24. When the user activates a particular application 22-24 during a user session at the computing device 10A, the “Retrieval” interface 18 interacts continuously with the currently active application 22, 23 or 24 and determines when it should perform the search and retrieval operations. For instance, when the currently active browser 22 is about to display a form page, then the “Retrieval” interface 18 determines that its search and retrieval operations should be triggered at that instance of using the browser 22. The search operation entails searching the local databases 15 to provide most appropriate meta data (i.e., application data) that can be used in a particular instance of using the currently active application. The retrieving operation entails retrieving the located meta data from the local databases 15 and supplying them to the active application 22-24 and/or the editor 25. The search and retrieval operations will now be discussed in more detail.

The search operation of the “Retrieval” interface 18 is accomplished using existing heuristics algorithms. Heuristics algorithms are well-known computer-implemented methods of iteratively solving problems based on prior usage data. In the present invention, the search operation relies on the stored context data and the statistical information to locate, using iterations, values (application data) that would be most appropriate for use in a current context. For instance, just before the browser is about to display a particular online form to be filled by the user, the “Retrieval” interface 18 searches for likely field values for the form based on the stored context data and the statistical information. To accomplish this, the “Retrieval” interface 18 evaluates data pertaining to the online form as transmitted by the form sender to determine the current context of the form (e.g., field names of the form, URI of the form, form name, etc.). Then the “Retrieval” interface 18 compares iteratively the user's past behaviors (i.e., stored context data and statistical information) in filling out the same or similar form with the context of the current online form to locate values (application data) that the user would most likely enter into the fields of the current online form. The current context of the form is identified by different properties describing the current context, and such context properties may be assigned different weights to indicate which properties should be given more weight during the search process.

Once the appropriate application data are found, then in the retrieval operation, the “Retrieval” interface 18 retrieves the application data from the user's meta data collection in the local databases 15 and supplies them to the appropriate application through the CDSA 30. The application then applies the received application data in the current context in which the application is used. In the above example, the browser 22 receives the appropriate application data (field values) from the “Remember” interface 18 and automatically fills in the fields of the current form with the retrieved data field values. If multiple field values are found for each field of the form, then the multiple values may be displayed for the user's selection, e.g., in a drop-down list.

In one embodiment, the “Retrieval” interface 18 implements the high-level searches to encompass different variations of identified search requirements according to known search techniques and rules. For instance, there exist a variety of different search rules that can be applied to perform searches and the “Retrieval” interface 18 is configured to apply these search rules appropriately or according to certain criteria to improve the search process. Examples of such search rules may include, but are not limited to, “Case Independent Rule” for disregarding the case (upper case or lower case) of search terms and data being searched, “Sounds-Like Rule” for automatically including terms that sound like the search terms but are spelled differently, “URL Match Rule” for considering any URL having at least a portion of the search term, or any URL having a portion that matches the search term, etc. The “Retrieval” interface 18 can be configured so that certain search rules can be selectively applied to certain situations.

Overall, the “Retrieval interface” 18 searches and retrieves from the user's meta data collection certain application data suitable for use in the current context of using the applications 22-24 to enhance the experience of the user in using the applications 22-24, whether it be browsing the Web, performing word-processing tasks, filling out computer forms, performing online transactions, or any other computer-based activities that can benefit from automation and customization by the device 10A.

The meta data editor 25 allows the user to edit, sort, and organize the meta data collection stored in the local databases 15 and to set certain criteria, if desired, by which the HAPI 14 operates its meta data storage, search and retrieval operations. The meta data editor 25 can also be used to request certain information from the user, such as the current role of the user. The meta data editor 25 preferably includes a Graphical User Interface (GUI) for communicating with the user and with the applications 22-24. One example of such a meta data editor GUI is found in a co-pending U.S. application Ser. No. 09/862,271, filed on May 22, 2001, assigned to the assignee of the present invention, and entitled “Data Cylinder for Managing Ad-hoc Data Sets”, which is herein fully incorporated by reference. The GUI disclosed in U.S. application Ser. No. 09/862,271 displays a cylindrically shaped graphical tool on a user's display device and allows sorting of different sets of meta data based on different roles or other criteria which can be set by the user.

New entries to the local databases 15 can be created and organized in many different ways. For instance, using the meta data editor 25, the user can manually enter new meta data into the local databases 15, e.g., using the data cylinder GUI discussed in the above-described co-pending application. In a different way, if the user enters data into a computer form on a web page, the data associated with that web page and the form are automatically collected by the “Remember” interface 16 and processed as discussed above. Before saving a new entry, the system can be configured to ask the user if the user desires to add certain meta data to the user's meta data collection. For example, a pop-up window, GUI or some other means can display a question such as this:

ADD Address of “23 Main Street, Durham, N.C. 12345” in association with

“Personal Role” and the web page of “www.ibm.com/shopping/thinkpad/my_order.html”?

The pop-up window or some other means could also list other addresses that are associated with this address field and invite the user to select from the list. These inquiries provide the user with an opportunity to enter and/or edit the meta data (if needed), not have it stored, or to indicate that it should be stored in some other manner, e.g., higher in the hierarchy or in association with a different site such as “www.ibm.com”. The user can also select the level of prompting desired, such as always, never, or prompt when there is a matching field higher in the hierarchy.

In the present invention, communication between the HAPI 14 and the currently active applications 22-24 and/or the editor 25 occurs in a secure manner because the CDSA 30 verifies the validity of the applications 22-24 and transmission using known verification techniques. The use of the CDSA configuration also permits the meta data collection to be accessed from the local databases 15 in a secure manner, well protected from unauthorized users, e.g., hackers. Further, the use of the CDSA is advantageous because the CDSA provides the security services discussed above and, at the same time, allows additional services provided by the HAPI 14 to be added easily as a plug-in to the CDSA. The overall architecture of the CDSA need not be changed to add such new services. Although the use of the CDSA is preferred, the present invention is not limited to such, and can be used in conjunction with other types of security architecture known in the art.

One skilled in the art would appreciate that each of the computing devices 10 can include any software and/or hardware components typically found in conventional computing devices such as processors, user input devices (e.g., keyboard, keypad, mouse, optical pen, microphone, etc.), user input device adapters, a display device, a display device adapter, audio output device, a network interface (e.g., modem, etc.), operating systems, etc. The Web browser 22 is any browser application known in the art, such as Microsoft Internet Explorer, Netscape Navigator, etc. The word processor application 23 is any word processor application known in the art, e.g., MS Word, Corel's WordPerfect, etc. The other application(s) 24 can be any other applications known in the art, such as spreadsheets, photo editors, finance programs, graphics programs, etc.

Now, one example of a meta data organization usable by the “Remember” interface 16 of the HAPI 14 will be discussed in more detail referring to FIGS. 3A and 3B. FIG. 3A shows an example of a computer form usable in the present invention, and FIG. 3B shows examples of (key, value) pairs obtainable from the computer form of FIG. 3A according to one embodiment of the present invention. As shown in FIG. 3A, assume that a computer form 40 to be filled by a user is presented to the user on the device 10A. The computer form 40 includes at least two fields 41 and 42, and a “Submit” button 43 for sending the completed form to an appropriate receiving party. The first field 41 is for entering the user ID and the second field 42 is for entering the pass code. The form 40 has the URL of “http://www.ibm.com”.

Given the form 40, the “Remember” interface 16 may collect meta data from the form 40, which are represented as a plurality of (key, value) pairs of the user's meta data collection, as shown in FIG. 3B. Particularly, for each of the data fields 41 and 42, a meta data group is established wherein the plurality of meta data groups constitute a meta data set. Each meta data group includes application data (in this case, a field value) and context data associated with that value. For instance, for the user ID field 41, the meta data group A is established. The meta data group A is composed of application data represented by a (key, value) pair 44 and context data represented by (key, value) pairs 45. The (key, value) pair 44 indicates that the value V of the field (key) 41 is “MPeters”. The context data 45 indicates the context in which the field value “MPeters” is used. In this case, the context of the field 41 is identified to be as follows: the name of the field 41 is “euser”, the description of the field 41 is “User ID”, the form 40 having the field 41 is called “customerinfo”, the URL of the form 40 is “http://www.ibm.com”, the URL referred in the form 40 is “http://www.ibm.product.com”, and the role of the user (i.e., role in which the user functioned in filling out this form) is “manager”. Similarly, the meta data group B established for the field 42 includes a (key, value) pair 46 indicating that the field value V is “123”, and context data 47 indicating the context of the field 42. The meta data groups A, B, . . . , are related to each other and constitute a meta data set wherein all the data belonging to the meta data set are related to each other. In this example, the user's role can be collected by requesting the user to specify the user's current role, e.g., using a pop-up window, the meta data editor 25 or some other means, or can be determined using other available meta data, e.g., by comparing the meta data with similar meta data stored in the local databases 15. This approach is applicable to all embodiments discussed herein.

If the “Retrieval” interface 18 needs to perform a search and retrieval operation to fill out a new computer form that is identical to the computer form 40 shown in FIG. 3A or is in a similar context, then the “Retrieval” interface 18 may search the user's meta data collection in the local repository based on the following exemplary search requirements:

Retrieve best 5 V Context (50%role=manager, 25%URL=http://www.ibm.com, 10%descript=User ID, 5%fieldname=euser,

10%RefURL=http://www.ibm.product.com);

Retrieve best 5 V Context (50%role=manager, 25%URL=http://www.ibm.com, 10%descript=Pass Code, 5%fieldname=verification,

10%RefURL=http://www.ibm.product.com); . . .

Here, “V” stands for a value. These search criteria are formulated based on the form information for the form 40, which the “Retrieval” interface 18 would have obtained from the browser 22 before the form 40 is displayed. The search criteria essentially represent the current context of filling in the new form with different weights (%) given to different context properties such as role, URL, descript, etc. This results in a search based on the weighted context corresponding to the current context of the new form. The weights assigned to the different context properties may be determined in advance and modified (if needed) by the system to find optimal solution(s), and they may differ depending on which application 22, 23 or 24 is being used in what context. In this example, the role of the user is assigned to 50% of the weight, indicating that the role is important (importance represented by weights) and should be given certain weight (50%) during the search process. The “Retrieval” interface 18 executes the search on the user's meta data collection by executing the heuristics algorithms to find optimal solution(s) that would satisfy these search requirements in an optimal manner. The statistical information is used in this process to find most appropriate (optimal) solutions. The optimal solutions(s) would be certain application data (e.g., likely values for the fields of the new form) that would be most appropriate for the current context of filling out the new form. In this manner, the meta data organization of the present invention permits data to be searched by URLs, user role and/or other context data.

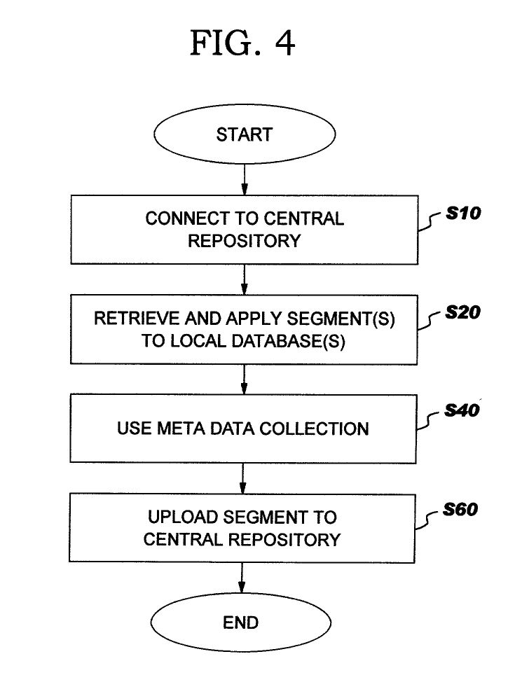

FIG. 4 is a flowchart illustrating the processing steps of a method for managing meta data using a central repository according to a preferred embodiment of the present invention. As shown in FIG. 4, at the start of a user session at a particular computing device, the central database manager 17 obtains the user's pass phrase and connection information (e.g., userid, repository network name, and password), and connects to the central repository at the subsystem 60 through the communications network such as the Internet 52 using the collected information from the user, in Step S10. The central repository subsystem 60 then lists any segments created or stored in the central repository after the segment representing the last segment applied (as a log) to the local databases 15, which is typically the segment representing the last user session on this computing device.

Then in Step S20, the central database manager 17 retrieves these segments in order (date-time), decrypts them into logs and applies them in an ordered fashion to the local databases 15 to update the user's meta data collection stored in the local databases 15. This results in a local database which represents all of the meta data and statistical information representing the user's prior sessions on this and all other computing devices.

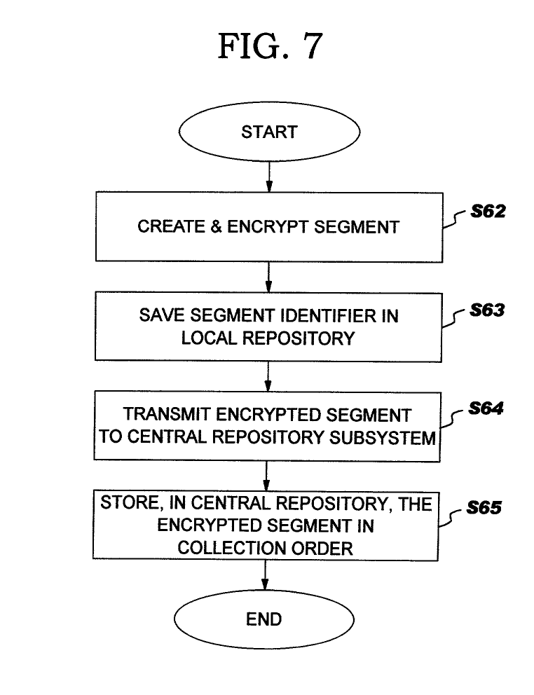

Then in Step S40, the central database manager 17 enables the HAPI 14 whereby the updated user's meta data collection is heuristically exploited to enhance the user's experience of using the applications 22-24 and/or meta data editor 25 as discussed above, and at the same time, turns on the process of collecting new meta data as logs of modifications during the user session. At the end of the user session and, perhaps, at certain checkpoints during the user session, the central database manager 17 temporarily locks the local databases 15, creates a new segment based on the logged modifications, encrypts the segment via the encrypt plug-in 19, uploads the encrypted segment to the central repository at the subsystem 60 via the communications network, resets its internal log file, and unlocks the local databases 15, in Step S60. It should be noted that the uploading of the meta data (segment) from the computing device 10A to the central repository can occur incrementally as meta data are generated or at one time upon completion of the user session by transmitting the new segment as described below in detail in connection with FIG. 7. This ends the process.

In certain cases, if the local database 15 is at a “null” stage (e.g., when a new computing device is being used or when the existing computing device is recovering from a local failure), a null date-time will be used to list all segments (logged changes) stored in the central repository, so that the local database 15 can be effectively rebuilt to the level of the last user session or checkpoint from the logged changes. In another embodiment, if the user's “pass phrase” is changed or when the number of segments in the central repository exceeds some garbage-collection threshold, then after applying the newest segments at the start of the user session at the computing device, the entire local database and/or central repository is dumped to a log which is then converted to a single segment. This single segment then replaces all the previous segments in the central repository for the current user. This activity may be gated by the device capabilities and/or the characteristics of the connection to the central repository. In still another embodiment, a segment representing all the changes applied to a null database starts with an indicator that will allow the central database manager 17 to reset the local database 15 to null before applying the modifications included in that segment. If the segment was built because of a pass phase change, then the indicator will carry an offset which will yield the previous pass phrase if it is added to the current pass phrase. This scheme allows the use of the new pass phrase on computing devices following a change on the computing device which results in the creation of a consolidated replacement segment.

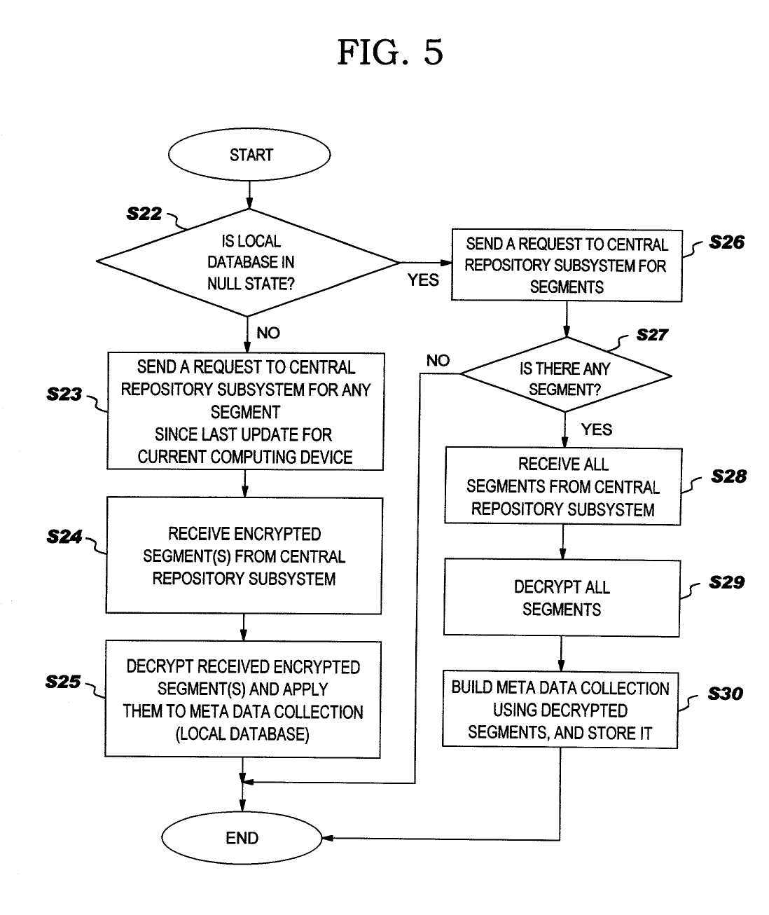

FIG. 5 is a flowchart illustrating the processing steps implementable as Step S20 of FIG. 4 according to one embodiment of the present invention. As shown in FIG. 5, in Step S22, at the start of the user session, the central database manager 17 of the computing device 10A determines if the local database 15 is at a null state for the current user. If this determination result is “no,” then the central database manager 17 in Step S23 instructs the central repository subsystem 60 to send all segments (in collection order) that were generated since the last update of the user's meta data collection (local database) at this particular computing device 10A.

Then, in Step S24, these segment(s), which will have been encrypted according to the segment encryption process discussed herein, are received by the data repository plug-in 20 through the communications network.

Then, in Step S25, the encrypt/decrypt plug-in 19 decrypts the encrypted segment(s) received from the central repository subsystem 60. Then, the decrypted segment(s) are applied to the user's current meta data collection under control of the central database manager 17 to update the user's meta data collection (i.e., local database). The updated meta data collection then will include the same information represented by the ordered collection of segments currently maintained at the central repository subsystem 60 for the user.

On the other hand, at Step S22, if the computing device 10A determines that the local database 15 is at the null state (e.g., because this is the user's first session at this computing device or the computing device is a publicly-shared device that prohibits local storage of meta data collections), then the central database manager 17 in Step S26 instructs the central repository subsystem 60 to transmit all segments that are associated with the user to the computing device 10A. In Step S27, if the repository manager 64 determines that there is no segment stored in the central databases 66 for the user (e.g., because this is the use's first session), then the process ends because no local repository updating is needed or possible.

However, if the central repository subsystem 60 determines at Step S27 that there is at least one segment stored in the central databases 66 for the user, then in Step S28, all available segments (logged changes in collection order) for the user are transmitted from the central repository subsystem 60 to the computing device 10A via the communications network. These segments will have been encrypted. Then in Step S29, the received encrypted segments are decrypted by the encrypt/decrypt plug-in 19. In Step S30, the central database manager 17 builds up a meta data collection for the user using the decrypted segments and stores it in the local databases 15 in association with the user. The building-up of the meta data collection may involve using the first segment as the starting meta data collection and applying subsequent segments (composed of logged add/delete/change transactions) to the meta data collection in the collection order. Then the local database updating process ends.

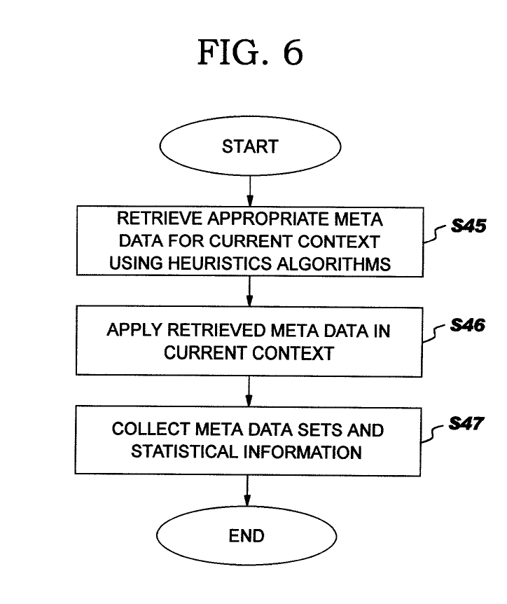

FIG. 6 is a flowchart illustrating the processing steps implementable as Step S40 of FIG. 4 according to one embodiment of the present invention. As shown in FIG. 6, once the local database updating process is completed at the start of the current user session at the computing device 10A, the central database manager 17 turns on the logging process and activates the HAP1 14. In Step S45, at certain instances of using the applications 22-24, appropriate meta data (i.e., application data) are retrieved from the user's current meta data collection in the local database 15 based on context data and statistical information. This can be accomplished using existing heuristic algorithms to generate search requirements based on the current context of using the applications 22-24 and to search the user's meta data collection for application data that satisfy the search requirements as discussed above. The user role for the current context may be determined by the system based on available data stored in the local database, or by requesting it from the user, e.g., using a pop-up window or the GUI of the meta data editor 25. In Step S46, the retrieved meta data are applied appropriately in the current context of using the application 22, 23 or 24, for example, for rendering a web page, filling in a computer form, etc. Steps S45 and S46 can be repeated as many times as possible during the user session at the computing device 10A.

In Step S47, the “Remember” interface 16 of the computing device 10A collects the meta data sets as the user uses the applications 22-24 and/or the meta editor 25 during the session. Then the process ends.

In certain instances, when there is no user's meta data collection in the local database 15, then the HAPI 14 of the computing device 10A collects the meta data sets as the user uses the application(s) 22-24 and/or the meta data editor 25 as discussed above. The collected meta data is used to create a meta data collection for the user, which is then transmitted to the central repository as the user's first segment.

FIG. 7 is a flowchart illustrating certain encryption and transmission substeps of Step S60 of FIG. 4 according to one embodiment of the present invention. As shown in FIG. 7, in Step S62, at the end of the user session or at certain check points or determined intervals, the central database manager 17 temporarily locks the local database 15, and creates a segment of logged changes corresponding to the collected meta data. Then, the encrypt/decrypt plug-in 19 encrypts the new segment using the encryption key which may be represented by a hash of the segment identifier in combination with the user's pass phrase as discussed above. Then, in Step S63, the identifier for this encrypted segment (e.g., the segment name) is stored in the local databases 15 so that this information can be used to determine when the last update occurred.

In Step S64, the encrypted segment is then transmitted from the computing device 10A to the central repository subsystem 60 through the communications network. Then the central database manager 17 resets its internal log file and unlocks the local database 15. In Step S65, the central repository subsystem 60 stores the received encrypted segment (or adds it to the existing ordered segments) in association with the user in the central repository. This completes the segment uploading process. Optionally, the user's meta data collection in the local databases 15 can be updated based on the new segment. The statistical information, indicating frequency with which certain application data are used together in the meta data sets, is also updated in the local databases 15 in association with the meta data sets. It should be noted that this optional step is performed only if local storage of meta data collections is permitted in the computing device. If this is not permitted (e.g., because the computing device is a publicly-shared device), then this step is omitted.

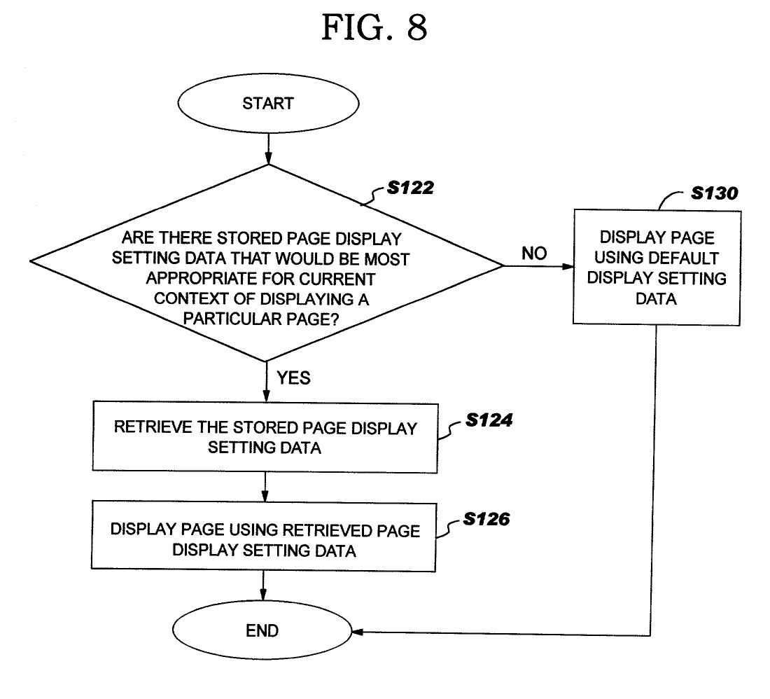

FIGS. 8-10 illustrate flowcharts illustrating the processing steps implementable as Steps S45 and S46 in FIG. 6 according to different embodiments of the present invention. All these processing steps can be implemented in each of the computing devices 10 of FIG. 2. However, for the sake of brevity, these steps will be explained using one computing device 10A. Specifically, FIG. 8 illustrates processing steps of Steps S45 and S46 in FIG. 6 in the context of rendering web pages. As the user browses through different web pages using the computing device 10A, the user may prefer these web pages to be displayed in different page settings depending on the context of the page (i.e., URI of the page, role of the user, etc). For instance, the user may prefer to view a particular page in a larger font size than other pages, or to view all pages in the same predetermined settings when the user functions in a particular role, e.g., as an IBM employee.

In this context, in Step S122, when a particular web page needs to be displayed to the user (e.g., in response to the user's request), it is determined if the user's meta data collection includes any page display setting data that would be most appropriate for the current context of displaying the particular web page. This determination can be made by performing the search operation of the “Retrieval” interface 18 based on the current context of the particular web page as discussed above. For instance, the “Retrieval” interface 18 may search the user's meta data collection to locate display setting data (application data) associated with context data that approximately matches the current context of the particular web page according to certain search requirements. If multiple application data sets are found, which is likely, the statistical information is relied upon to select an application data set from the multiple application data sets that is most frequently used by the user in a context most closely representing the current context.

If the determination result at Step S122 is “yes”, then the most appropriate page display setting data are retrieved from the local repository by the “Retrieval” interface 18 in Step S124. Then, in Step S126, the retrieved page display setting data are applied during the displaying process to display the current web page according to the retrieved data. To accomplish this, the “Retrieval” interface 18 sends the retrieved page display setting data to the Web browser 22 through the CDSA 30 and the browser 22 displays the current page using the retrieval display setting data. On the other hand, at Step S122, if it is determined that there is no page display setting data that would be most appropriate for the current context of displaying the page, then the Web browser 22 at Step S130 is configured to display the currently requested page using default settings or other predetermined settings, and this process ends.

Accordingly, the present invention renders automatically different web pages according to different rendering settings that are preferred or likely preferred by the user. This feature enhances the Web browsing experience of the user significantly. One skilled in the art would readily appreciate that the processing steps of FIG. 8 are not limited to Web page display operations, but are applicable to any output operations. For example, the steps of FIG. 8 are applicable to providing differential settings for the speech synthesis rendering of a web page. In another example, the steps of FIG. 5 are applicable to displaying files (e.g., word processor files, graphics files, etc.), where the context data may identify the names of the files, user roles, etc.

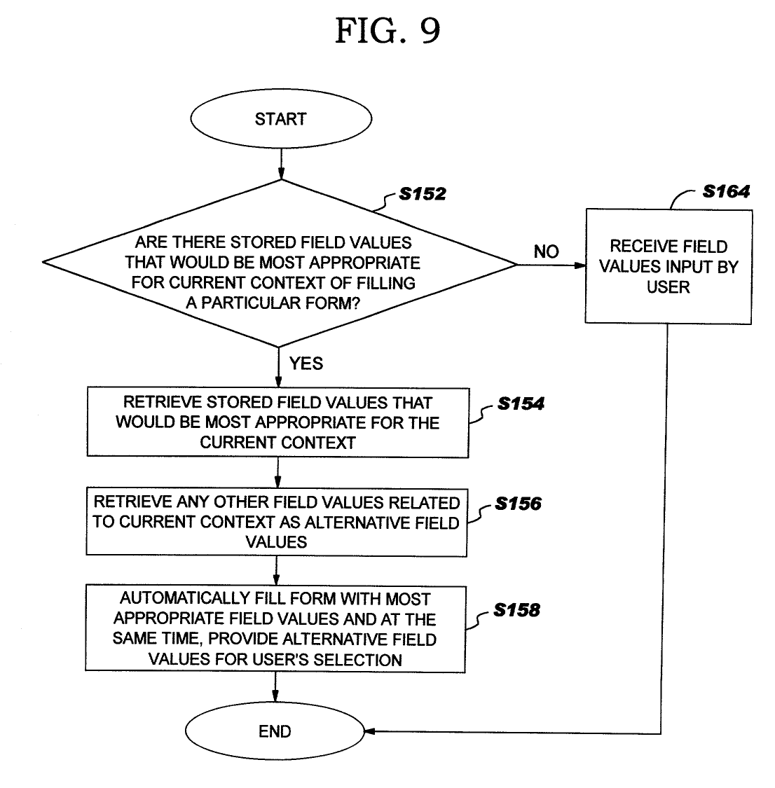

FIG. 9 illustrates another application of Steps S45 and S46 in FIG. 6 in the context of filling in a computer form according to one embodiment of the present invention. As shown in FIG. 9, in Step S152, when a particular web page containing one or more forms needs to be displayed to the user (e.g., in response to the user's request), then the “Retrieval” interface 18 of the computing device 10A determines if the user's meta data collection includes any field values that would be most appropriate for the current context of filling in this particular form. This determination is made based the results of a heuristics search operation performed by the HAPI 14 based on the current context of the particular form as discussed above. If the determination result at Step S152 is “yes”, then in Step S154, the located field values are retrieved from the local databases 15 by the “Retrieval” interface 18. Then in Step S156, the “Retrieval” interface 18 further searches the local databases 15 and retrieves from the local databases 15 any other field values (if available) that may be related to the current context of the form, so that they can be used as alternative field values possibly usable to fill the fields of the current form. For example, the statistical information can be used to locate values that would be second-most appropriate for the current context of the form, or the first several most-appropriate values offered in decreasing order of probability for the current context of the form.

Then in Step S158, all the fields of the current form are automatically and simultaneously filled in with the most appropriate field values retrieved in Step S154, e.g., under control of the Web browser 22. At the same time, the alternative is field values retrieved in Step S156 may also be displayed to the user for the user's consideration. This can be accomplished under control of the meta data editor 25. For example, for each field on the current form, a drop-down list, a pop-up window or a graphical data cylinder displaying the alternative field values may appear on the user's screen so that the user can select, if desired, one of the alternative field values for the particular field. In this manner, the user can either accept the field values that are automatically filled in, or can select one of the alternative field values for the fields of the form. In addition or as an alternative, the user can manually enter the values into the form or modify the existing values.

On the other hand, if it is determined at Step S152 that the user's meta data collection does not include any field values that would be most appropriate for the current context of filling in the form, then the process moves to Step S164 wherein the computing device 10A receives field values manually input by the user, for example, from a keyboard or keypad. Then the process ends.

Accordingly, the present invention automatically suggests, using heuristics algorithms, possible values for the data fields of computer forms based on the user's prior form filling acts. As a result, although the field names of the forms may not be identical, more accurate suggestions for the fields can be made. In addition, all the fields of the computer forms can be filled automatically at one time.

In the embodiments discussed in connection with FIG. 9, one skilled in the art would readily appreciate that the automatic filling of the form can occur after the blank form is displayed to the user, or prior to the displaying of the form. In the latter

case, the user will not see the blank form, but the filled form will be displayed at once.

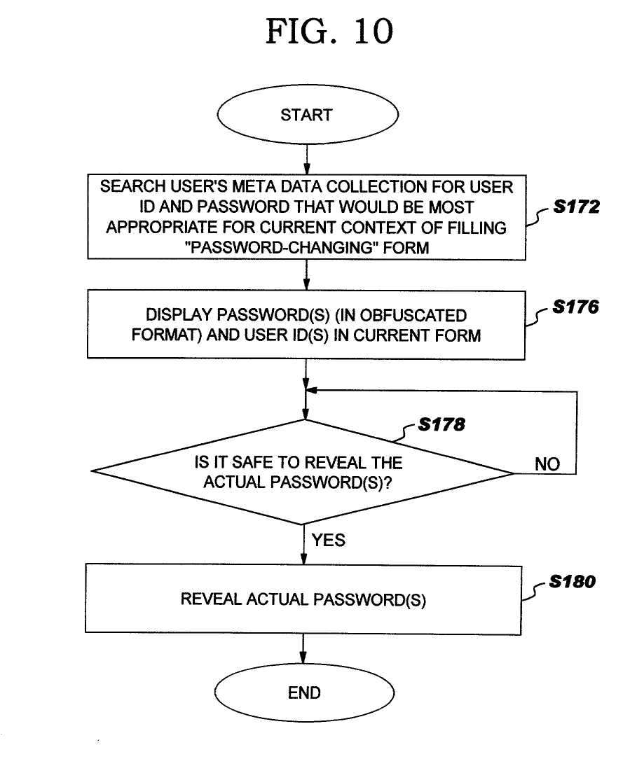

FIG. 10 illustrates another application of Steps S45 and S46 in FIG. 6 in the context of filling in a “password-changing” form. A password-changing form is any known computer form for changing the user's password. As shown in FIG. 10, in Step S172, when a particular password-changing form is displayed on the display unit of the computing device 10A, the user's meta data collection in the local databases 15 is searched by the “Retrieval” interface 18 of the device 10A to locate a user ID/password combination that would be most appropriate for the current context of filling in the particular form. This is accomplished by performing the search and retrieve operations of the “Retrieval” interface 18 using heuristics algorithms as discussed above. The search operation will locate one or more user IDs and passwords that may be most appropriate for the fields of the current form. Then in Step S176, the located user ID(s) and password(s) are then retrieved from the local databases 15 and automatically filled into the appropriate fields of the current password-changing form such as the “old ID” and “old password” fields. The user ID(s) are displayed so that the user can see what they are, whereas the password(s) are displayed in obfuscated format (e.g., using strings of asterisks) so that no one can see what the actual password(s) are. In this way, the password(s) can be protected from being seen by unauthorized individuals.

Then in Step S178, the user is requested to determine whether it is safe to reveal the actual password(s). This can be accomplished, e.g., using the meta data editor 25, or by providing a pop-up window or prompt requesting the user's approval for revealing the actual password(s). If it is determined based on the user's input that the actual password(s) can be revealed (e.g., because no one is near the user), in Step S180 the actual password(s) are revealed to the user and the process ends. The displaying of the actual password(s) does not occur until the user informs the computing device 10A that it is O.K. to display the actual password(s). To increase security, in one embodiment, the user may need to enter a particular code or the like to verify that the user's approval for displaying the actual password(s) is an authorized one. If only one password is displayed, the user reviews it as well as the user ID to verify that they are acceptable. If multiple user IDs and/or passwords are displayed, then the user must select one of the displayed user IDs and one of the displayed passwords for the current form.

It should be noted that the processes of FIGS. 5-10 can be implemented sequentially or simultaneously, if appropriate. For instance, when a form page is to be displayed, the form page can be displayed according to the steps of FIG. 8 and simultaneously be filled with field values according to the steps of FIG. 9.

Although the present invention has been discussed above in connection with displaying or visually providing certain information to a user, e.g., in FIGS. 8 and 10, the present invention is not limited to such, but is equally applicable to customizing and/or personalizing information to be rendered to a user in any manner, not just visually.

In one embodiment, if the URI is used as a context property to search the meta data collection in the local databases 15, the “Retrieval” interface 18 searches the entire URI string first. If no matches are found, then the beginning portions or other predetermined portions of the URI may be searched. For example, if the URI of “www.ibm.com/shopping/thinkpad/my_order.html” is searched and no hits are found for this URI, then the system may be configured to look for an entry that matches just “www.ibm.com/shopping” or “www.ibm.com.”

In another embodiment, each field value that is suggested to the user for selection is visibly identified for the user so that the user knows the identity of the field to which it pertains. For example, suggested address values for the “address” field might be identified to the user as follows:

ADDRESS (PERSONAL ROLE): 1000 J. Hind Street, Durham, N.C. 12345

ADDRESS (IBM EMPLOYEE ROLE): P.O. Box 12195, Research Triangle Park, N.C. 23232.

By labeling the suggested values appropriately, the user is able to quickly recognize these values for what they are, and the user's selection process can be facilitated significantly.

In still another embodiment, the meta data collections can be stored in the local databases 15 in encrypted form, and can only be accessed if the user supplies proper credentials, such as a user ID and password, biometric identification, etc. This can be implemented using the security functions provided by the CDSA 30, or by adding an encryption plug-in as a new service provider module to the CDSA 30 or other equivalent security architecture implementation.

It should be clearly understood that the process of selecting most appropriate meta data that would be suitable for the current context of using the application based on the past behavior of the user, according to the present invention, is applicable to any application or situation where meta data is requested. For example, in some applications, a particular website that the user is interacting with may employ well-established Secured Sockets Layer (SSL) encryption techniques. The SSL techniques allow the website to perform an SSL handshake with the user's browser so that secured data can be transmitted between the user's device and the website server. Conventional browsers utilize a predetermined client side certificate/public-private key pair to perform the SSL handshake with the user's device, and, sometimes, this certificate/public-key is passed to the website server as a verification of the user's identity. However, according to the present invention, before performing an SSL handshake, the Web browser 22 is configured to communicate with the HAPI 14 which in turn selects a certificate/public-key from the user's meta data collection that is associated with the current context of selecting a certificate/public-key (e.g., user role and/or the URI that the browser is in the process of loading). If the search results by the HAPI 14 indicate that there are multiple certificates/public-keys that satisfy this criterion, then the system is configured to display to the user these certificates/public-keys by name in a pop-up window, a pull-down list, or some other manner, along with their associated context data (e.g., user role, URI). One of the certificates/public-keys that is most likely to match the current situation of the user may be highlighted or distinguished from other certificates/public-keys in some manner. The user can then view the certificates/public-keys, accept or reject the certificate/public-key (if there is only one), or select one certificate/public-key (if there are multiple) to be used for the SSL handshake. The user is also able to set criteria by which the system operates in connection with the certificate/public-key selection. For instance, the user can indicate to the system whether a default certificate/public-key should be selected based on the role without further consultation with the user, or whether the user prefers to always be prompted when a default certificate/public-key has to be used.

In another example, when a server requests a cookie from the browser 22, the HAPI 14 can be configured to retrieve the user's cookie based on the current role of the user (e.g., as an individual) and as a result, the browser will return the user's cookie that is appropriate for the current context.

The local databases 15 are organized hierarchically using any prior art database management techniques, but may be sorted according to different criteria. As discussed above, the meta data collections maintained in the local databases 15 are stored, preferably, in (key, value) pairs, and may be encoded, e.g., using known XML encoding or other encoding techniques. Certain keys in the (key, value) pairs may be predefined by the system, or created dynamically by the system and/or user.

In another embodiment, at least one of the central repository and the local database(s) can be implemented by using a network-attached storage known in the art.

In still another embodiment, the data repository plug-in shown in FIG. 2 can reside on a “proxy” machine connected to the CDSA by using a secure protocol. This configuration is allowed by the CDSA and would be ideal for a low-end device that may not necessarily have the processing/memory power to store and/or manage the heuristic database(s) but have a high-speed channel connection available to the proxy machine which is now possible with new digital cell phone networks, radio LANs, etc. For instance, a low-end device such as a certain PDA or cell phone can be configured to connect to the proxy machine (having the data repository plug-in) through an available high-speed connection. The proxy machine in turn connects to the server/central repository browser or the like to access and interact with the central repository.

Accordingly, the present invention provides a system and method which studies the history of the user's past behaviors in using different applications and data editors and which provides intelligent recommendations and functions that would improve greatly the user's current experience of using the applications, whether it be for web browsing, data processing, communicating with other users, executing application programs, etc. The features are not limited to one computing device, but the present invention adds mobility to the system by collecting meta data from multiple computing devices (e.g., from a user's home desk top, office workstation, wireless PDA, etc.), centrally storing the meta data at a central repository subsystem and synchronizing data maintained in the computing devices and the central subsystem with minimal network traffic in a secure manner.

The processing steps of the present invention can be implemented by computer programs in conjunction with hardware components if needed. Software programming code which embodies the present invention may be stored on any of a variety of known media such as a server, database, diskette, hard drive, CD-ROM, or read-only memory, and may be distributed on such media. The techniques and methods for embodying software programming code on physical media and/or distributing software code are known in the art.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A method of managing meta data using a central repository at a central repository subsystem, the central repository being accessible by a computing device through a communications network, the method comprising the steps of:
connecting to the central repository through the communications network based on a user input;
updating a local repository of the computing device with at least one segment from the central repository that is associated with the user to produce a meta data collection associated with the user; and
utilizing, by the computing device, the meta data collection during a current user session at the computing device to assist the user in using the computing device.

2. The method of claim 1, further comprising the step of:
uploading any new segment from the computing device to the central repository at a predetermined time.

3. The method of claim 1, further comprising the step of:
incrementally uploading any new meta data generated during the current user session from the computing device to the central repository.

4. The method of claim 1, wherein the connecting step includes:
receiving, by the central repository subsystem, authentication information from the user;
verifying validity of the authentication information; and
notifying the computing device that the user has proper authority to access the central repository if the authentication information is verified as valid.

5. The method of claim 4, wherein the authentication information includes user identification, a pass phrase of the user, and an identifier for the central repository or a component at the central repository subsystem.

6. The method of claim 5, wherein the verifying step includes:
determining a secret key represented as a hash of the received user identification concatenated with a hash of the received identifier encrypted with the received pass phrase; and
comparing the secret key with a stored key associated with the user.

7. The method of claim 1, wherein the updating step includes:
determining if the local repository is at a null state;
first requesting the central repository subsystem to transmit any segment associated with the user that has not been applied to the computing device if the determining step indicates that the local repository is not at a null state; and
second requesting the central repository subsystem to transmit all segments associated with the user if the determining step indicates that the local repository is at a null state.

8. The method of claim 7, wherein the updating step further includes:
receiving at least one segment from the central repository subsystem in response to said first requesting step;
decrypting the at least one segment; and
applying the decrypted at least one segment to the meta data collection to produce the meta data collection associated with the user.

9. The method of claim 7, wherein the updating step further includes:
receiving at least one segment from the central repository subsystem in response to said second requesting step;
decrypting the at least one segment; and
generating the meta data collection for the user using the decrypted at least one segment.

10. The method of claim 1, wherein the utilizing step includes:
retrieving, using heuristics algorithms, from the meta data collection, meta data that would be most appropriate for a current context of using the computing device; and
applying the retrieved meta data in the current context.

11. The method of claim 10, wherein the current context includes at least one of the following: opening a web page, filling in a computer form, filling in a password-changing form, providing a certificate, opening a computer file, processing a computer file, or executing an application program.

12. The method of claim 10, wherein the utilizing step further includes:
continuously collecting meta data resulting from use of the computing device during the current user session at the computing device; and the method further comprises:
generating a new segment based on the collected meta data upon completion of the current user session; and
processing the new segment.

13. The method of claim 12, wherein the processing step includes:
updating the meta data collection with the new segment if said meta data collection exists in the local repository; and
storing the new segment in the local repository as a meta data collection for the user if said meta data collection does not exist in the local repository.

14. The method of claim 12, wherein the meta data includes application data for being usable in an application executable on the computing device, and context data for identifying context in which said application data are used, and wherein the utilizing step further includes:
determining statistical information associated with the meta data, the statistical information indicating relationships between the meta data, wherein the retrieving step is performed in part based on the statistical information.

15. The method of claim 14, wherein the context data identify at least one of the following: user roles, uniform resource identifiers (URIs), file names, and/or form names pertaining to the application data.

16. The method of claim 14, wherein the application data include at least one of the following: page display setting data, file display setting data, user ID/password combinations, field values for computer forms, user's preference data, bookmarks, and certificates.

17. The method of claim 10, wherein the current context is for filling in a computer form, and the applying step includes:
automatically filling in the computer form with said most appropriate meta data.

18. The method of claim 10, wherein, if the current context is for filling in a computer form, the utilizing step further includes:
retrieving, from the meta data collection, alternative meta data that are related to the current context of filling in the computer form; and
presenting the alternative meta data to the user for the user's consideration.

19. The method of claim 10, wherein the current context is for filling in a password-changing computer form, and the retrieved meta data includes a user identification and a password, and wherein the applying step includes:
presenting to the user the password in an obfuscated format;
determining whether it is safe to present the actual password to the user; and
presenting the actual password in a non-obfuscated format when it is determined to be safe to present the actual password.

20. The method of claim 1, wherein the utilizing step includes:
formulating search requirements based on a current context of using the computing device; and
executing a search based on the search requirements using the heuristics algorithms.

21. The method of claim 20, wherein the search requirements specify weighted properties of the current context of using the computing device.

22. The method of claim 1, further comprising the step of:
providing a graphical user interface (GUI) for allowing the user to organize the meta data collection.

23. The method of claim 22, wherein the GUI displays a graphical tool in a cylindrical configuration for organizing the meta data collection.

24. The method of claim 2, wherein the uploading step includes:
temporarily locking the local repository;
encrypting the new segment using an encryption key;
transmitting the encrypted new segment from the computing device to the central repository subsystem for storage in the central repository; and
unlocking the local repository.

25. The method of claim 24, wherein, in the encrypting step, the encryption key is represented as a hash of identifying information associated with the new segment, concatenated with a pass phrase of the user.

26. The method of claim 1, wherein the computing device implements a Common Data Security Architecture (CDSA), and the utilizing step is performed by a CDSA add-on module.

27. The method of claim 1, wherein the central repository subsystem is implemented using WebDAV protocols.

28. A computer program product embodied on computer readable medium readable by at least one of a computing device and a central repository subsystem, for managing meta data using a central repository at the central repository subsystem, the central repository being accessible by the computing device through a communication network, the computer program product comprising computer executable instructions for:
connecting, through the communications network, to the central repository based on a user input;
updating a local repository of the computing device with at least one segment from the central repository that is associated with the user to produce a meta data collection associated with the user; and
utilizing, by the computing device, the meta data collection during a current user session at the computing device to assist the user in using the computing device.

29. The computer program product of claim 28, further comprising computer executable instructions for:
uploading any new segment from the computing device to the central repository at a predetermined time.

30. The computer program product of claim 28, further comprising computer executable instructions for:
incrementally uploading any new meta data generated during the current user session from the computing device to the central repository.

31. The computer program product of claim 28, wherein the computer executable instructions for connecting include computer executable instructions for:
receiving, by the central repository subsystem, authentication information from the user;
verifying validity of the authentication information; and
notifying the computing device that the user has proper authority to access the central repository if the authentication information is verified as valid.

32. The computer program product of claim 31, wherein the authentication information includes user identification, a pass phrase of the user, and an identifier for the central repository or a component at the central repository subsystem.

33. The computer program product of claim 32, wherein the computer executable instructions for verifying include computer executable instructions for:
determining a secret key represented as a hash of the received user identification concatenated with a hash of the received identifier encrypted with the received pass phrase; and
comparing the secret key with a stored key associated with the user.

34. The computer program product of claim 28, wherein the computer executable instructions for updating include computer executable instructions for:
determining if the local repository is at a null state;
first requesting the central repository subsystem to transmit any segment associated with the user that has not been applied to the computing device if the local repository is not at a null state; and
second requesting the central repository subsystem to transmit all segments associated with the user if the local repository is at a null state.

35. The computer program product of claim 34, wherein the computer executable instructions for updating further include computer executable instructions for:
receiving at least one segment from the central repository subsystem in response to said first requesting instructions;
decrypting the at least one segment; and
applying the decrypted at least one segment to the meta data collection to produce the meta data collection associated with the user.

36. The computer program product of claim 34, wherein the computer executable instructions for updating further include computer executable instructions for:
receiving at least one segment from the central repository subsystem in response to said second requesting instructions;
decrypting the at least one segment; and
generating the meta data collection for the user using the decrypted at least one segment.

37. The computer program product of claim 28, wherein the computer executable instructions for utilizing include computer executable instructions for:
retrieving, using heuristics algorithms, from the meta data collection, meta data that would be most appropriate for a current context of using the computing device; and
applying the retrieved meta data in the current context.

38. The computer program product of claim 37, wherein the current context includes at least one of the following: opening a web page, filling in a computer form, filling in a password-changing form, providing a certificate, opening a computer file, processing a computer file, or executing an application program.

39. The computer program product of claim 37, wherein the computer executable instructions for utilizing further include computer executable instructions for:
continuously collecting meta data resulting from use of the computing device during the current user session at the computing device; and the method further comprises computer executable instructions for:
generating a new segment based on the collected meta data upon completion of the current user session; and
processing the new segment.

40. The computer program product of claim 39, wherein the computer executable instructions for processing include computer executable instructions for:
updating the meta data collection with the new segment if said meta data collection exists in the local repository; and
storing the new segment in the local repository as a meta data collection for the user if said meta data collection does not exist in the local repository.

41. The computer program product of claim 39, wherein the meta data includes application data for being usable in an application executable on the computing device, and context data for identifying context in which said application data are used, and wherein the computer executable instructions for utilizing further include computer executable instructions for:
determining statistical information associated with the meta data, the statistical information indicating relationships between the meta data, wherein the computer executable instructions for retrieving are performed in part based on the statistical information.

42. The computer program product of claim 41, wherein the context data identify at least one of the following: user roles, uniform resource identifiers (URIs), file names, and/or form names pertaining to the application data.

43. The computer program product of claim 41, wherein the application data include at least one of the following: page display setting data, file display setting data, user ID/password combinations, field values for computer forms, user's preference data, bookmarks, and certificates.

44. The computer program product of claim 37, wherein the current context is for filling in a computer form, and the computer executable instructions for applying include computer executable instructions for:
automatically filling in the computer form with said most appropriate meta data.

45. The computer program product of claim 37, wherein, if the current context is for filling in a computer form, the computer executable instructions for utilizing further include computer executable instructions for:
retrieving, from the meta data collection, alternative meta data that are related to the current context of filling in the computer form; and
presenting the alternative meta data to the user for the user's consideration.

46. The computer program product of claim 37, wherein the current context is for filling in a password-changing computer form, and the retrieved meta data includes a user identification and a password, and wherein the computer executable instructions for applying include computer executable instructions for:
presenting to the user the password in an obfuscated format;
determining whether it is safe to present the actual password to the user; and
presenting the actual password in a non-obfuscated format when it is determined to be safe to present the actual password.

47. The computer program product of claim 28, wherein the computer executable instructions for utilizing include computer executable instructions for:
formulating search requirements based on a current context of using the computing device; and
executing a search based on the search requirements using the heuristics algorithms.

48. The computer program product of claim 47, wherein the search requirements specify weighted properties of the current context of using the computing device.

49. The computer program product of claim 28, further comprising computer executable instructions for:
providing a graphical user interface (GUI) for allowing the user to organize the meta data collection.

50. The computer program product of claim 49, wherein the GUI displays a graphical tool in a cylindrical configuration for organizing the meta data collection.

51. The computer program product of claim 29, wherein the computer executable instructions for uploading include computer executable instructions for:
temporarily locking the local repository;
encrypting the new segment using an encryption key;
transmitting the encrypted new segment from the computing device to the central repository subsystem for storage in the central repository; and
unlocking the local depository.

52. The computer program product of claim 51, wherein the encryption key is represented as a hash of identifying information associated with the new segment, concatenated with a pass phrase of the user.

53. The computer program product of claim 28, wherein the computing device is configured in Common Data Security Architecture (CDSA), and the computer executable instructions for utilizing are performed by an add-on module to the CDSA configuration.

54. The computer program product of claim 28, wherein the central repository subsystem is implemented using WebDAV protocols.

55. A system for managing meta data in a secure manner, the system comprising:
a central repository subsystem including a central repository for storing a plurality of segments associated with a user in a collection order; and
at least one computing device capable of communicating with the central repository subsystem through a communications network, the computing device including a local repository and being capable of connecting, through the communications network, to the central repository based on a user input, updating the local repository with at least one of the segments from the central repository to produce a meta data collection associated with the user, and utilizing the meta data collection during a current user session at the computing device to assist the user in using the computing device.

56. The system of claim 55, wherein the computing device uploads any new segment to the central repository at a predetermined time.

57. The system of claim 55, wherein the computing device incrementally uploads to the central repository any new meta data generated during the current user session.

58. The system of claim 55, wherein the computing device further includes:
a plurality of applications selectably executable on the computing device;
a security-service providing architecture structure for selectively providing security-based services to at least one of the plurality of applications;
a data repository module, provided as an add-in module to the security-service providing architecture, for utilizing the meta data collection to assist the user in using the computing device; and
an encryption/decryption module for encryption any new segment to be transmitted to the central repository subsystem.

59. The system of claim 55, wherein the central repository subsystem further includes a manager for managing the central repository, and wherein the central repository subsystem receives from the computing device authentication information input by the user, verifies validity of the authentication information, and notifies the computing device that the user has proper authority to access the central repository if the authentication information is verified as valid.

60. The system of claim 59, wherein the authentication information includes user identification, a pass phrase of the user, and an identifier for the central repository or a component at the central repository subsystem.

61. The system of claim 59, wherein the central repository subsystem determines a secret key represented as a hash of the received user identification concatenated with a hash of the received identifier encrypted with the received pass phrase, and compares the secret key with a stored key associated with the user to verify the user's authentication information.

62. The system of claim 58, wherein the data repository module determines if the local repository is at a null state, transmits a first request to the central repository subsystem to transmit any segment associated with the user that has not been applied to the computing device if the local repository is not at a null state, and transmits a second request to the central repository subsystem to transmit all segments associated with the user if the local repository is at a null state.

63. The system of claim 62, wherein the encryption/decryption module receives at least one segment from the central repository subsystem in response to said first request, and decrypts the at least one segment, and wherein the data repository module applies the decrypted at least one segment to the meta data collection to produce the meta data collection associated with the user.

64. The system of claim 62, wherein the encryption/decryption module receives at least one segment from the central repository subsystem in response to said second request, and decrypts the at least one segment, and wherein the data repository module generates the meta data collection for the user using the decrypted at least one segment.

65. The system of claim 58, wherein the data repository module retrieves using heuristics algorithms, from the meta data collection, meta data that would be most appropriate for a current context of using the computing device, and transmits the retrieved meta data to an appropriate one of the applications which in turn applies the retrieved meta data in the current context.

66. The system of claim 65, wherein the current context includes at least one of the following: opening a web page, filling in a computer form, filling in a password-changing form, providing a certificate, opening a computer file, processing a computer file, or executing an application program.

67. The system of claim 65, wherein the data repository module continuously collects meta data resulting from use of the computing device during the current user session at the computing device, and generates a new segment based on the collected meta data upon completion of the current user session.

68. The system of claim 67, wherein the data repository module updates the meta data collection with the new segment if the meta data collection exists in the local repository, and stores the new segment in the local repository as a meta data collection for the user if the meta data collection does not exist in the local repository.

69. The system of claim 67, wherein the meta data includes application data for being usable in an application executable on the computing device, and context data for identifying context in which said application data are used, and wherein the data repository module determines statistical information associated with the meta data and retrieves said appropriate meta data based on the statistical information, the statistical information indicating relationships between the meta data.

70. The system of claim 69, wherein the context data identify at least one of the following: user roles, uniform resource identifiers (URIs), file names, and/or form names pertaining to the application data.

71. The system of claim 69, wherein the application data include at least one of the following: page display setting data, file display setting data, user ID/password combinations, field values for computer forms, user's preference data, bookmarks, and certificates.

72. The system of claim 65, wherein the current context is for filling in a computer form, and said appropriate one of the applications automatically fills the computer form with said most appropriate meta data.

73. The system of claim 65, wherein, if the current context is for filling in a computer form, the data repository module retrieves, from the meta data collection, alternative meta data that are related to the current context of filling in the computer form, and transmits the alternative meta data to said appropriate one of the applications which in turn presents the alternative meta data to the user for the user's consideration.

74. The system of claim 65, wherein the current context is for filling in a password-changing computer form, and the retrieved meta data includes a user identification and a password, and wherein the data repository module controls said appropriate one of the applications to present to the user the password in an obfuscated format, determines whether it is safe to present the actual password to the user, and controls said appropriate one of the applications to present the actual password in a non-obfuscated format when it is determined to be safe to present the actual password.

75. The system of claim 58, wherein the data repository module formulates search requirements based on a current context of using the computing device, and executes a search based on the search requirements using the heuristics algorithms.

76. The system of claim 75, wherein the search requirements specify weighted properties of the current context of using the computing device.

77. The system of claim 55, further comprising:
a meta data editor for allowing the user to organize the meta data collection.

78. The system of claim 77, wherein the meta data editor displays a graphical tool in a cylindrical configuration for organizing the meta data collection.

79. The system of claim 58, wherein the data repository module temporarily locks the local repository and creates the new segment based on collected meta data; the encryption/decryption module encrypts the new segment using an encryption key; and the data repository module transmits the encrypted new segment to the central repository subsystem for storage in the central repository and unlocks the local repository.

80. The system of claim 79, wherein the encryption key is represented as a hash of identifying information associated with the new segment, concatenated with a pass phrase of the user.

81. The system of claim 58, wherein the computing device is configured in Common Data Security Architecture (CDSA), and the data repository module is an add-on module to the CDSA configuration.

82. The system of claim 55, wherein the central repository subsystem is implemented using WebDAV protocols.

83. The system of claim 55, wherein at least one of the central repository and the local repository is implemented using a network-attached storage.

84. The system of claim 58, wherein the data repository module resides on a proxy machine accessible through a predetermined connection means.
